(19) United States
(12) Patent Application Publication
(10) Pub. No.: US 2003/0029708 A1
(43) Pub. Date: Feb. 13, 2003

(54) Key switch

(76) Inventors: Ching-Chiang Yu, Keelung (TW); Yong Te Tsao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/925,459

(22) Filed: Aug. 10, 2001

(51) Int. Cl. H01H 13/70

(52) U.S. Cl. 200/344

(57) ABSTRACT

A key switch, comprising a key base, a key cap, and a first linking member and a second linking member are installed between the key base and the key cap, and a flexible member installed on the first linking member. The flexible member can be a spring, and is curved outwardly at its normal position. The second linking member has a pressing lever that is in contact with the flexible member. When the key switch is pressed down, the pressing lever compresses the flexible member, causing the flexible member to change its shape from an outward curve to a straight line, then further to an inward curve, producing a sense of two-step touch control. When the pressing force is released, the resilient force of the flexible member restores the key switch to its original position, thereby requiring the installation of any rubber components.

### BACKGROUND OF THE INVENTION

1. Field of the Invention

The invention relates to a key switch, especially to a keyboard for notebook computer, involving a flexible member to produce a sense of two-step touch control, thereby to restore the key switch to its original position without the installation of rubber components.

2. Background of the invention

Conventional key switches of keyboards have been aimed to reduce the measurements of key switches, for use on a notebook computer keyboard. Therefore, almost all designs employ crossed linking members to transmit the pressing operation of key switches. But there should be a feeling of two-step touch control during the pressing operation. Therefore, connecting rods or inconsistent constructions are normally used on key switches to enable such feeling of two-step touch control, which are too sophisticated to enable convenient assembling.

Furthermore, for smoothly restoring to its original position after the pressing force applied on the key switch is released, normally there is a rubber component installed in the key switch, the rubber component serving to provide the resilience required to restore the key switch to its original position. For the purpose of providing the feeling of two-step touch control and restore the key switch to its normal position, it requires sophisticated construction that could mean increased working hours and labor in the assembling process, as well as increased costs.

### SUMMARY OF THE INVENTION

The primary objective of the invention is to provide a key switch, comprising a key base, a key cap, a first linking member and a second linking member that cross and inter-link with each other, and a flexible member that is installed on the first linking member. The second linking member has a pressing lever in contact with the flexible member. When the key switch is pressed down, the pressing lever compresses the flexible member downward, causing the flexible member to change its shape from an outward curve to a straight line, then to an inward curve, producing the feeling of two degrees of applying force. When the pressing force is released, the resilience of the flexible member drives the key switch to restore its original, normal position.

Because the flexible member is employed on the key switch to produce the feeling of two-step touch control and restore the key switch to its original position, without the installation of a rubber component or sophisticated constructions, thereby reducing its production costs, simplify its assembling processes, extend its service life and achieving the objective of the applicability of the invention.

The drawings of preferred embodiments of this invention are described in following details to enable better understanding.

### BRIEF DESCRIPTION OF DRAWINGS

FIG. 1 is a perspective view of the key switch of the invention, with only the key cap disassembled.

FIG. 2 is an exploded view of the key switch of the invention.

FIGS. 3 and 4 are cross-sectional views of the invention, showing the key switch in operating process.

### DETAILED DESCRIPTION OF PREFERRED EMBODIMENTS

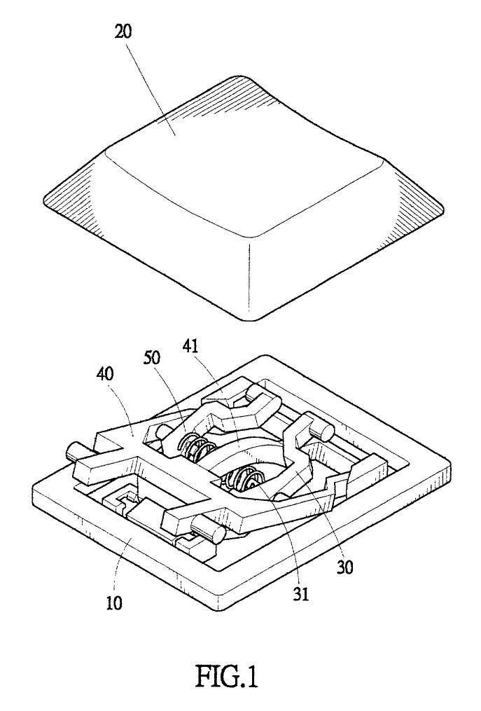

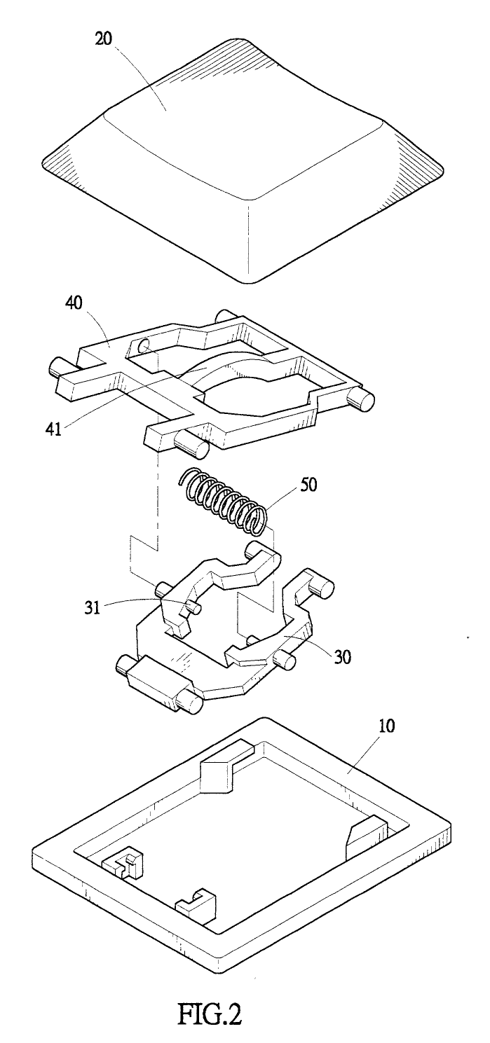

As shown in FIGS. 1 and 2, the key switch of the invention comprises a key base 10, a key cap 20, a first linking member 30 and a second linking member 40. The first and second linking members 30, 40, crossing and inter-linking with each other, are installed between the key base 10 and the key cap 20.

A flexible member 50, in the form of a spring, is installed on the first linking member 30. The first linking member 30 has a fixing pin 31, onto which the flexible member 50 can be mounted. The flexible member 50, when normally positioned, is compressed to curve outward. The second linking member 40 has a pressing lever 41 that is in contact with the flexible member 50.

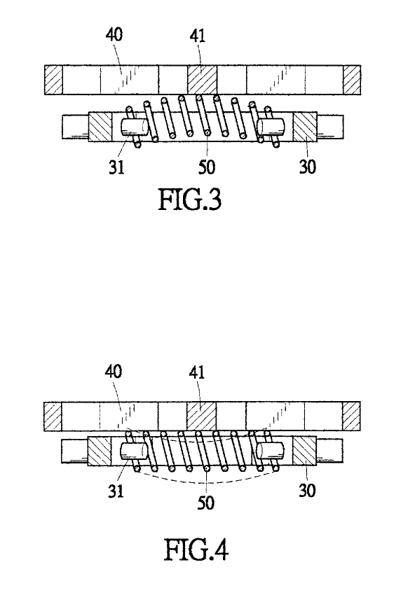

Please refer to FIGS. 3 and 4. When the key switch is pressed down, the pressing lever 41 of the second linking member 40 compresses the flexible member 50, so that the flexible member 50 is compressed from the shape of an outward curve to become a straight line, then further bent inwardly, giving a sense of two-step touch control. When the pressing force is released, the resilient force of the flexible member 50 pushes the second linking member 40 upward, the second linking member 40 in turn drives the first linking member 30 and the key cap upward, to resume the key switch to its original, normal position.

What is claimed is:

1. A key switch, comprising a key base, a key cap, and a first linking member and a second linking member that are installed between the key base and the key cap, wherein
a flexible member is installed on the first linking member;
the second linking member having a press lever which is in contact with the flexible member;
when the key switch is pressed down, the pressing lever of the second linking member compresses the flexible member, causing the flexible member to deform, and when the pressing force is released, the resilient force of the flexible member causes the key switch to resume its original position.

2. The key switch as claimed in claim 1, wherein the flexible member is a spring.

3. The key switch as claimed in claim 1, wherein the first linking member has a fixing pin, whereby the flexible member can be mounted onto the first linking member.

4. The key switch as claimed in claim 1, wherein the flexible member in its normal condition is curved outwardly, and when it is compressed, the flexible member changes its shape from an outward curve to a straight line, then further to an inward curve, producing the sense of two-step touch control.
